(19) United States
(12) Patent Application Publication
(10) Pub. No.: US 2003/0212601 A1
(43) Pub. Date: Nov. 13, 2003

(54) Credit card SMS portal transmission system and process

(76) Inventors: Ivan Silva, Hillsborough, NJ (US); Alvaro Pereira de Moraes Filho, Curltiba (BR)

Correspondence Address: Mark D. Saralino, Nineteenth Floor, 1621 Euclid Avenue, Cleveland, OH, 44115-2191, US

(21) Appl. No.: 10/281,819

(22) Filed: Oct. 28, 2002

Related U.S. Application Data
(60) Provisional application No. 60/379,027, filed on May 9, 2002.

(51) Int. Cl. G06F 17/60

(52) U.S. Cl. 705/17

(57) ABSTRACT

A point-of-sale payment system for facilitating remote payment of goods and services is described. A point-of-sale (POS) terminal communicates secure point-of-sale financial information to an authentication gateway through a wireless network. The authentication gateway instructs an e-commerce gateway to place an order for at least one item and to transfer funds associated with the at least one item to a respective account. The e-commerce gateway validates the request from the authentication gateway and notifies the authentication gateway whether the transaction was successful. The authentication gateway forwards the status to the POS terminal.

### CROSS REFERENCE TO RELATED APPLICATIONS

This Application claims priority from U.S. Provisional Application Serial No. 60/379,027 filed May 9, 2002, which is incorporated herein by reference.

### FIELD OF THE INVENTION

The present invention relates to credit card transactions. More particularly, the invention relates to a system and method for providing a secure point-of-sale payment system that is highly mobile.

### BACKGROUND OF THE INVENTION

Various standards define the global telephone system currently operating to define the exchange of data, voice and signaling messages. For example, a well known standard, such as Signaling System #7 written by Committee Centrale International Telephone and Telegraphique (CCITT, SS #7), renamed as International Telecommunication Union (ITU), specifies a protocol defining how signaling messages are to be interchanged on a world wide basis among telecommunication systems.

An adjunct to these standards, the Global System for Mobile Communications Cellular Standard (GSM 03.4) authored by European Telephone Standards Institute (ETSI), and Interim Standard 41 (IS-41) authored by the Electronics Industry Association (EIA) and Telecommunication Industry Association (TIA) for the Cellular Telecommunications Industry Association (CTIA) defines how communications are to be conducted over wireless (air) connections for voice and signaling.

A part of the CCITT SS #7 standard defines Transaction Capability Application Part (TCAP). This Part defines the protocol used to send and receive inquiries and associated responses for real time telecommunication applications over land (wire) lines or satellite systems. TCAP is used to implement Short Messaging service. Some of the Short Messaging features are defined for the air interface, for example, by GSM, IS-41, IS-54 in conjunction with TCAP. These cellular standards generally define the transfer of user specified “short” text messages between wireless terminals (cellular telephones) equipped for this purpose. The Short Messaging service can typically be used for such applications as exchanging “short” text messages between terminal equipment.

A “short” text message interchange between a mobile terminal and a typical cell transmitter/receiver is conducted on a signaling channel, over the air interface, as specified, for example, by GSM, IS-41, IS-54 and other standards. These signaling related messages are specified to be transmitted on a frequency band generally separate from the band used for voice transmission. Therefore, signaling related messages typically do not occupy the same frequencies allocated for voice transmission, unless additional message carrying capacity is required. The transaction capability of signaling messages allows messages of about 140 characters to be exchanged between wireless terminals. Generally, at low to moderate traffic levels, the 140 character messages can be sent without using the frequencies allocated for, or interfering with, voice transmissions on the same wireless terminals. With increased traffic levels, some of the voice allocated transmission capacity may be used for signaling messages.

Furthermore, a Short Message System, generally referred to as a Short Message Service Center (SMSC), specifies that a full, two way, voice channel connection need not be established between wireless entities for the exchange of signaling messages. That is, the signaling messages are generally exchanged via a SMSC and a (cellular) mobile terminal automatically upon occurrence of a specific event, such as the presence or entry of a cellular terminal within a cell. This exchange is completed without establishing a full time, two way interconnection, where a two way channel is opened and reserved. There is generally enough capacity for Short Messages (SM) in a signaling network to be used for new applications.

In general, the CCITT (ITU), GSM, IS 41, IS 54 and other specifications descriptive of a typical SMSC define generally only the methods and procedures required by the telephone network to transfer a Short Message (SM) between terminals and do not discuss any functions beyond those required for telephone operation. A cellular mobile telecommunication switching system is discussed in U.S. Pat. No. 5,396,543. A use of Short Messages has been described in general in U.S. Pat. No. 5,351,235. An adapter for use with Short Messages is described in U.S. Pat. No. 5,353,328. Certain encryption methods and apparatus applicable to this invention are also discussed in U.S. Pat. No. 4,405,829 describing a public key type (RSA algorithm) encryption, U.S. Pat. No. 3,962,539 describing, in general, DES block encryption, and U.S. Pat. No. 5,214,703 describing, in general the IDEA algorithm, another block type encryption algorithm. U.S. Pat. Nos. 4,797,9213 and 4,408,203 assigned to Mastercard International describe an electronic fund transfer system, and a security system for fund transfer using encryption techniques, respectively. U.S. Pat. Nos. 5,255,182 and 5,177,342 assigned to Visa International Service Association describe a system for determining the level of quality of transactions conducted from a point-of-sale terminal. U.S. Pat. No. 4,796,292 assigned to American Express Company describes a credit card authorization network and references the Visa protocol for dial-up credit card transactions. The above recited patents, GSM, CCITT (ITU), Interim Standards 41 and 54, EIA/TIA, and CTIA specifications discussed above are incorporated herein by reference in their entirety.

Presently, payment via credit card typically is limited to fixed locations, such as department stores, restaurants, etc. This limitation presents a problem for the merchant who is highly mobile, such as a taxi driver or a merchant who does business in an outdoor market, for example. Mobile solutions have not been cost effective since they involve spectrum utilization, which can be very costly. Additionally, present mobile solutions depend on the deployment of a wireless network for operations, adding further cost to the mobile solution.

Accordingly, it would be advantageous to provide a payment system that allows the “mobile merchant” as well as the “fixed location merchant” to accept payment via credit card. Therefore, there is a need in the art for a point-of-sale payment system that provides a secure environment for the transmission of financial information and is highly mobile. Additionally, it would be advantageous to provide a point-of-sale payment system that has minimal startup costs for the end user.

### SUMMARY OF THE INVENTION

In the light of the foregoing, one aspect of the invention relates to a point-of-sale payment system, which includes a point-of-sale (POS) terminal, a wireless network, an authentication gateway, and an e-commerce gateway, wherein the POS terminal communicates secure point-of-sale information with the authentication gateway through the wireless network, and the authentication gateway prepares instructions for a fund transfer and transmits the instructions to the e-commerce gateway, and the e-commerce gateway executes the instructions.

A second aspect of the invention relates to an apparatus for facilitating a point of sale (POS) payment transaction, which includes a storage device, a processor connected to the storage device, and a program for controlling the processor, said program stored on the storage device, wherein the processor is operative with the program to receive a remote payment request from a merchant, wherein said processor identifies the merchant, creates instructions for facilitating the payment request and transmits the instructions to a web page for performing the payment request.

A third aspect of the invention relates to a method for using a computer to facilitate a point-of-sale payment between a buyer and a merchant, including the steps of inputting financial information relating to the buyer into the computer, identifying the merchant requesting the transaction, creating code that automatically fills in purchase information on a merchant's web page, and transmitting the code to the merchant's web page, wherein the merchant's web page executes the code.

A fourth aspect of the invention relates to a point-of-sale payment method, which includes the steps of communicating financial information from a point-of-sale (POS) terminal to an authentication gateway, wherein the communications are secure and conducted through a wireless network, constructing instructions for an e-commerce gateway to perform an electronic fund transfer, wherein the instructions are constructed by the authentication gateway, and transmitting the instructions to the e-commerce gateway, wherein the e-commerce gateway executes the instructions and reports a result to the authentication gateway, and the authentication gateway reports the result to the POS terminal.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a simplified block diagram of a point-of-sale system in accordance with an embodiment of the present invention.

FIG. 2 is a block diagram of a point-of-sale terminal in accordance with an embodiment of the present invention.

FIG. 3 is a block diagram of an authentication gateway in accordance with an embodiment of the present invention.

FIG. 4 is a simplified block diagram illustrating the elements of a merchant database in accordance with an embodiment of the present invention.

FIG. 5 is a flowchart detailing a credit card transaction in accordance with an embodiment of the present invention.

FIG. 6 is a simplified block diagram of a point-of-sale system in accordance with another embodiment of the present invention.

FIG. 7 is a simplified block diagram illustrating the elements of a merchant database in accordance with another embodiment of the present invention.

FIG. 8 is a flowchart detailing a credit card transaction in accordance with another embodiment of the present invention.

FIG. 9A is a flowchart detailing the operation of an authentication gateway in accordance with an embodiment of the present invention.

FIG. 9B is a continuation of the flow chart of FIG. 9A in accordance with an embodiment of the present invention.

FIG. 9C is a continuation of the flow chart of FIG. 9A in accordance with another embodiment of the present invention.

### DETAILED DESCRIPTION OF THE INVENTION

The following is a description of the present invention in conjunction with the attached drawings, wherein like reference numerals will refer to like elements throughout.

Typically in consumer sales transactions, goods and services are paid for on credit using credit cards. Credit card transactions offer an attractive alternative to cash transactions since they relieve the buyer from the burdens associated with carrying cash. Moreover, many credit card companies offer incentives or perks, such as travel insurance, warranty protection, cash back awards, etc. when their cards are used to purchase goods and services. Due in part to these convenience factors, society is moving away from cash based transactions and gravitating towards credit or “electronic transactions”. Unfortunately, existing electronic transaction systems present obstacles for the small merchant and/or the merchant who does business in a remote setting, such as an outdoor market, for example.

It is noted that throughout the present disclosure, reference will be made to payment by credit card. Payment by credit card, however, is merely an exemplary payment means and it is not intended to be limiting in any way. Other payment means, such as debit cards, smartcards, etc. are contemplated to be within the scope of the present invention.

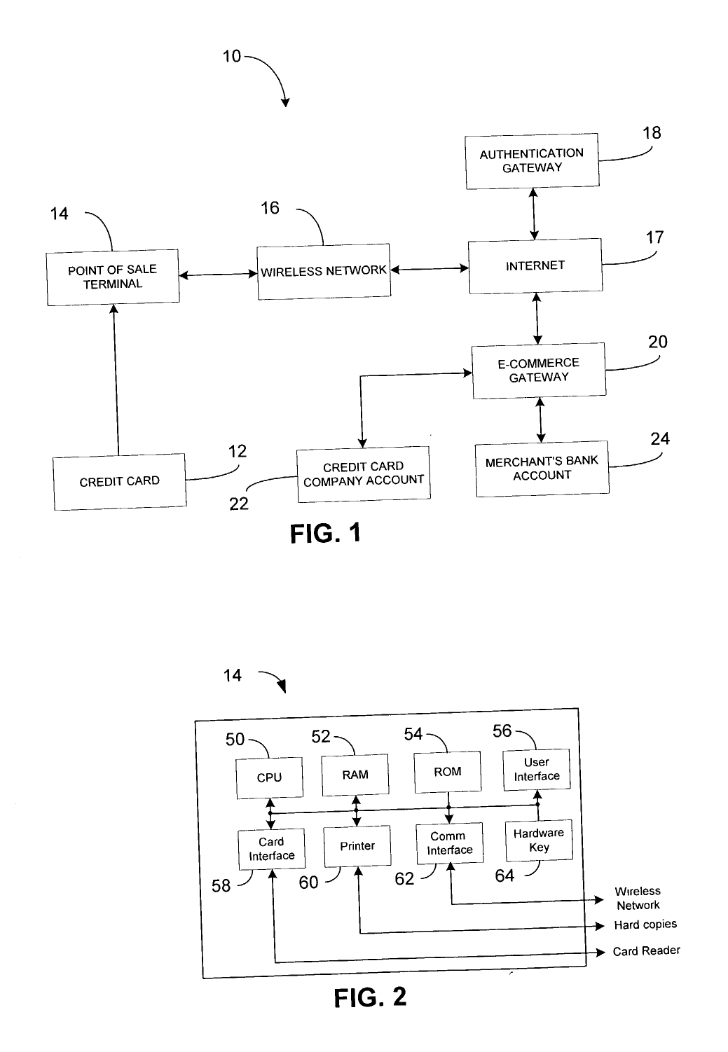

Referring to FIG. 1, a point-of-sale (POS) payment system 10 in accordance with an embodiment of the present invention is illustrated. The embodiment illustrated in FIG. 1 relates to POS payment transactions wherein the merchant deals with goods that are located at the sale site and/or at a remote location. For example, a kiosk for a cellular phone vendor may have numerous phones displayed at the kiosk. In addition, the cellular phone vendor may have numerous models which are not located at the kiosk but may be selected from a catalog and shipped to the buyer. A customer browsing through the available items at the kiosk may select an item on display, or he may select an item listed in a catalog which may or may not be located at the kiosk. Regardless of the location of the item, the merchant may accept payment for the item using the POS payment system 10, and the customer can accept the item immediately or have it delivered to him or Her at a later date.

The POS payment system 10 allows a merchant to accept payment via electronic transactions, e.g., a credit card 12, without incurring substantial up-front costs that are associated with implementing such systems. Moreover, the POS payment system 10 facilitates electronic transactions in remote locations. The POS payment system 10 accomplishes these features by utilizing a POS terminal 14 to access existing wireless networks 16 and the Internet 17 to communicate to an authentication gateway 18, which coordinates the transaction, as will be described in more detail below.

Operation of the POS payment system 10 now will be briefly described. When a customer is ready to purchase an item, he submits his credit card 12 for payment and the credit card 12 is read by the POS terminal 14. Typically, the reading operation is accomplished by “swiping” the credit card 12 through a magnetic reader (not shown) in the POS terminal 14. It is noted, however, that a magnetic reader is merely exemplary and other readers may be implemented without departing from the scope of the invention. Such readers include, for example, electronic readers and bar code readers. In addition to reading the card 12, a transaction amount is entered into the POS terminal 14 through a user interface, such as a keypad, for example. As the information is entered into the POS terminal 14, the POS terminal 14 accesses the wireless network 16, e.g., an existing digital cellular network, connects to the Internet 17, and initiates communications with the authentication gateway 18. As will be appreciated by those having ordinary skill in the art, the POS terminal 14 accesses the internet 17 by using the wireless network 16 to connect to a network gateway (not shown), which is coupled to a wired network, e.g., the internet 17.

The POS terminal 14 uses a narrow band channel to transmit a message, and implements Short Message Service (SMS), for example. SMS is provided by a Short Message Service Center (SMSC), which is associated with the wireless network 16. SMS messages have a pre-determined size, e.g., 140 bytes, although processes exist that allow messages greater than the maximum size to be sent over the narrowband channel. An SMS communications system can be thought of as a client-server type of system where a client device makes a request, and upon reception, a server device acknowledges whether or not the request was received in tact. In the case of SMS, the acknowledgments represent a success report if the request was successfully received or an error report if the request was not successfully received. For example, when a mobile device sends a message to an SMSC, the SMSC returns a report to the mobile device to either confirm receipt of the message or to notify of error in the delivery of the message. If the message is received successfully, the SMSC stores and forwards the message to an entity capable of receiving SMS messages. This forwarded message contains the address of the originating entity. In a similar fashion, when the SMSC delivers a message to a mobile device, the mobile device returns a report to the SMSC to either confirm receipt of the message or to notify of error in the delivery of the message.

The initial communications between the POS terminal 14 and the authentication gateway 18 sets up a secure link between the POS terminal 14 and the authentication gateway 18. Once a secure link is established, the POS terminal 14 proceeds to transmit the order information, including the financial information, to the authentication gateway 18. The authentication gateway 18 receives the information, processes the information, and, through the Internet 17, submits instructions to the e-commerce gateway 20. The e-commerce gateway 20 executes the instructions and directs the credit card company to transfer funds from the credit card company's account 22 to the merchant's bank account 24. Furthermore, the e-commerce gateway 20 places an order for the item purchased in the merchants order entry system (not shown). For example, the merchant may have an order management system that tracks the merchant's inventory. By automatically entering order information into the order management system, the merchant quickly and accurately can retrieve inventory information. In addition, the order management system also may track order shipments, customer information, customer preferences, etc. Upon completion of the transaction, an email message detailing the result of the transaction is sent from the e-commerce gateway 20 to the authentication gateway 18, which forwards the message to the POS terminal 14. The authentication gateway 18 transmits the message to the POS terminal 14 using the narrow band channel, and implements SMS, for example. The POS terminal displays the result and, if the transaction was successful, prints a receipt. If the transaction was not successful, a message is displayed on the POS terminal 14 and/or the message is printed.

As can be seen from FIG. 1, the components of the POS payment system 10 utilize existing networks and/or gateways. More specifically, the POS payment system 10 utilizes existing digital cellular networks, Internet connectivity, and e-commerce gateways in conjunction with the POS terminal 14 and the authentication gateway 18 to provide a simple and cost-effective means of providing a POS payment system.

Throughout this disclosure, reference will be made to the Internet 17 and an e-commerce gateway 20. The Internet 17 is well known by those having ordinary skill in the art and will not be discussed in detail herein. Briefly, the Internet is a global collection of networks connecting and sharing information through a common set of protocols. It allows computers attached to networks to communicate effectively regardless of make, architecture, operating system or location.

An e-commerce gateway 20, as used herein, includes the infrastructure for facilitating commercial activity conducted over networks linking electronic devices (mainly computers). E-commerce itself is well known by those skilled in the art. Currently, e-commerce is conducted over the Internet using personal computers connected through an Internet service provider to the Internet, where a wide variety of different commerce opportunities are made available. Using suitable browser software, the user communicates with an e-commerce server or host computer via a web page to obtain information about products and services or to engage in a commercial transaction. The web page includes tools for purchasing goods and services online, such as a shopping cart, which allows a customer to pick the items he wishes to purchase, and an electronic payment means to facilitate remote payment of purchased goods and services.

A shopping cart is a piece of software that acts as an online store's catalog and ordering process. Typically, a shopping cart is the interface between a company's web site and its deeper infrastructure, allowing customers to select merchandise; review what they have selected; make necessary modifications or additions; and purchase the merchandise.

Electronic payments can take on many forms. However, a common feature of electronic payments is an electronic fund transfer (EFT). In an EFT, the payment means, such as a credit card or bank debit card, is used in combination with a Personal Identification Number (PIN), to transfer funds from one account to another. Data is encrypted to provide a secure link and to prevent unauthorized use of the data, thus minimizing the possibility of fraudulent activity. EFTs are a convenient and secure method for remote payment of goods and services. Presently, the infrastructure for implementing EFTs is available and in wide use.

Thus, an e-commerce gateway 20, as used herein, is defined to include the above described infrastructure for conducting commercial activity over networks, including the hardware and the software required to complete an electronic commercial transaction. More specifically, the e-commerce gateway 20 includes a merchant web page, wherein online commercial transactions may be executed.

Referring now to FIG. 2, the POS terminal 14 will be described in more detail. The POS terminal 14 includes a CPU 50 and RAM 52, which are used to execute code stored in ROM 54. A user interface 56 provides visual information to a user, e.g., a liquid crystal display (LCD), as well as a means to enter information into the POS terminal 14, e.g., a keypad. The POS terminal 14 also includes a card interface 58 for reading credit card information into the system. As mentioned previously, the card interface 58 may be a magnetic reader, a bar code reader, a chip card reader (e.g., for reading a smart card), or any other means used for reading information from a card. A printer 60 provides hard copies, such as receipts, to the customer and merchant upon completion of the transaction. In one embodiment, the printer is a thermal printer. A communications interface 62 supplies a link between the POS terminal 14 and the wireless network 16. Examples of a communication interface include an infrared interface, an IEEE 802.11 interface, a Bluetooth interface, and a serial link via a cable. Alternatively, the communication interface 62 may be a cell phone, e.g., a cellular transmitter and receiver, built into the POS terminal 14. The POS terminal 14 also includes a hardware key 64, which has an electronic serial number for identification purposes. In one embodiment, the POS terminal 14 is battery-powered via an onboard battery. In another embodiment, the POS terminal 14 is powered externally.

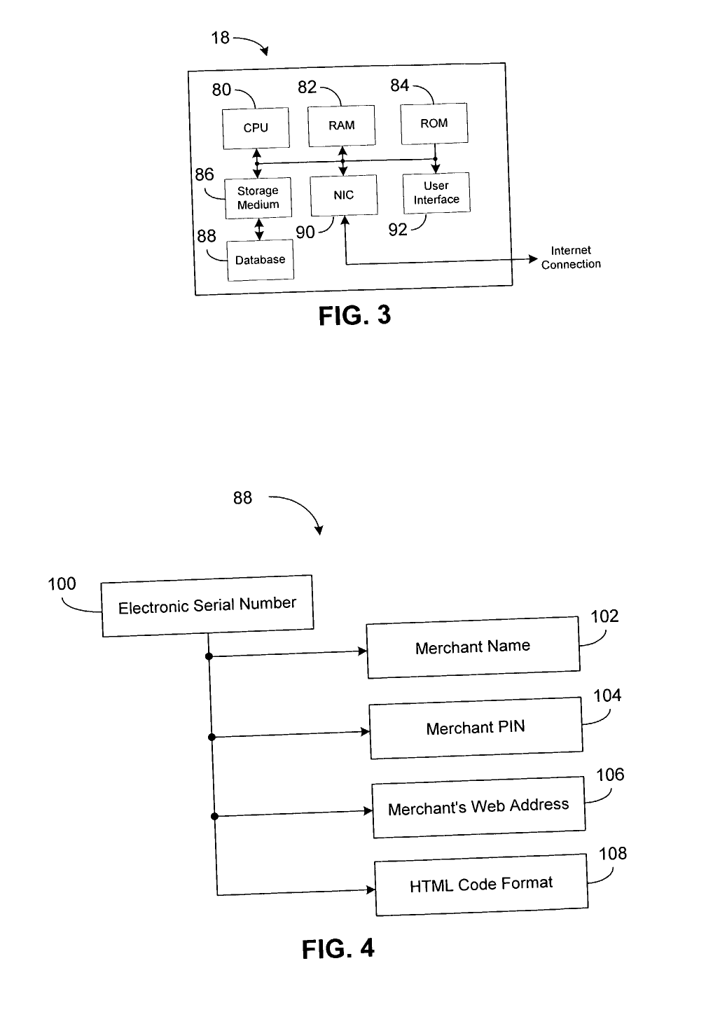

Moving to FIG. 3, the authentication gateway 18 is illustrated. The authentication gateway 18 includes a CPU 80 and RAM 82 for executing code stored in ROM 84. Furthermore, code executed by the CPU 80 also may be stored on a storage medium 86, such as a hard drive, for example. In addition to storing code for execution by the CPU 80, the storage medium 86 also contains a merchant database 88. The merchant database 88 provides merchant specific information relating to order processing and billing. The CPU 80 accesses the merchant database 88 and retrieves information relating to the specific merchant. The merchant database 88 will be discussed in more detail below. A network interface card (NIC) 90 provides an interface to the Internet 17, which in turn provides a link to the wireless network 16 and to the e-commerce gateway 20. In one embodiment, the NIC 90 implements a TCP/IP protocol. A user interface 92, such as a keyboard and/or display, provides access to the authentication gateway 18 for setup and maintenance purposes.

Referring now to FIG. 4, the merchant database 88 will be described in more detail. The merchant database 88 includes entries relating to the identity of the merchant requesting the credit card transaction, and entries relating to order entry and payment to the merchant, e.g., a code format for the shopping cart checkout procedure within the merchant's web page (discussed below).

As described above, the POS terminal 14 has a hardware key 64 that includes an electronic serial number 100. As will be described in more detail below, the electronic serial number 100 is part of the message that is transmitted from the POS terminal 14 to the authentication gateway 18. In the merchant database 88, the electronic serial number 100 is associated with various merchant specific entries. These entries include, for example, the merchant's name 102, the merchant's PIN 104, the merchant's web address 106, and the Hyper Text Markup Language (HTML) code format 108 for constructing HTML code for the shopping cart checkout procedure within the merchant's web page.

As discussed previously, communications between the POS terminal 14 and the authentication gateway 18 is accomplished through a wireless network 16, such as a digital cellular phone network, for example. In one embodiment, the information exchanged over the wireless network 16 is a short message service (SMS) format. Short message service is well known by those having ordinary skill in the art and will not be discussed in detail herein. Briefly, short message service enables a user to send messages to, and receive messages from, other users of a communications network. The SMS attempts to deliver a message to a mobile terminal whenever the terminal is registered to the network, even when the terminal is engaged in a voice or data call. The terminal also may roam throughout the network and still be capable of sending and receiving messages. A terminal configured for SMS provides methods for the user to receive, read, write/edit, clear, send, and save messages. The service makes use of a short message service center (SMSC), which acts as a store and forward system for short messages. Currently, SMS operates in the narrow band range, e.g., 64 kHz and below.

An advantage of using SMS is that mobility is independent of spectrum utilization, thus making SMS cost effective. Furthermore, use of existing cellular infrastructure eliminates the need for deployment of a wireless network.

In the present invention, the point-of-sale terminal 14 operates as if it were a public a virtual computer terminal programmed to access an online web page. Moreover, the point-of-sale terminal 14 also operates like a regular mobile phone and its electronic serial number is used to identify its user at the authentication gateway 18. The authentication gateway 18, on the other hand, basically is a computer with a software database that is capable of identifying the originator of the SMS message. In particular, the authentication gateway 18 identifies the merchant, accesses the merchant's web page, creates code to automatically fill out a payment form on the web page for a specific item or service offered for sale by the merchant, and sends the information to the web page for payment processing as if the end-user were paying for the product or service via the Internet.

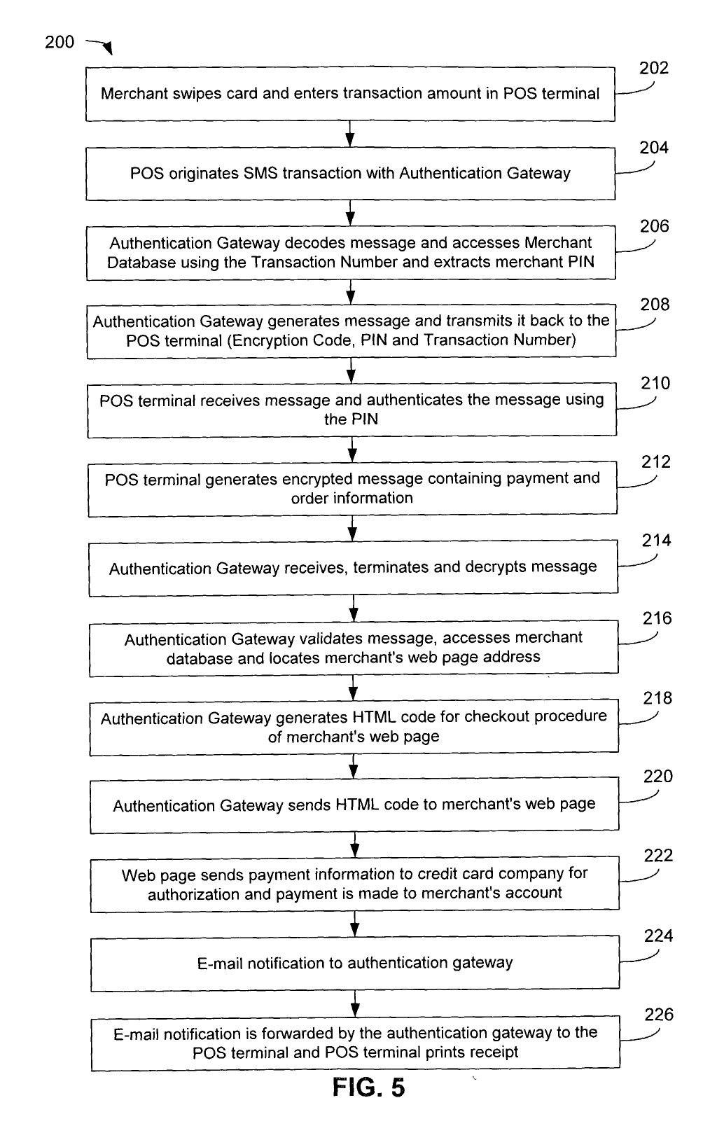

Referring now to FIG. 5, a flow chart 200 is illustrated detailing the operation of the POS payment system 10. Once a customer has selected the items he wishes to purchase, he proceeds to pay for the items. Using the customer's credit card 12, the merchant (or the customer) swipes the card through the card reader in the POS terminal 14 and enters the transaction amount using the keypad of the user interface 56, as shown in step 202. Optionally, the credit card information may be manually typed into the POS terminal 14 using the keypad of the user interface 56, for example. Visual information relating to the status of the transaction is displayed on the LCD of the user interface 56. At step 204, the POS terminal 14 originates an SMS transaction with the authentication gateway 18, and sends the POS terminal phone number and a transaction number.

The authentication gateway 18 scans the received message and extracts the POS terminal phone number and the transaction number. Using the transaction number, the authentication gateway 18 accesses the merchant database 88 and extracts a PIN corresponding to the transaction number, as shown at step 206. At step 208, the authentication gateway 18 generates a random encoding number and, using the POS terminal phone number, originates an SMS message back to the POS terminal 14. The SMS message from the authentication gateway 18 includes the PIN associated with the original transaction number, the transaction number, and the random encoding number.

It is noted that a new random encoding number is generated for each new transaction between the POS terminal 14 and the authentication gateway 18. A proprietary random encoding number system generates a unique number each time a credit card transaction is requested by the POS terminal 14. An algorithm known only by the POS terminal 14 and the authentication gateway 18 uses the random generated number to encode and decode the SMS message.

At step 210, the POS terminal 14 receives the message from the authentication gateway 18 and scans for the PIN, transaction number, and the random encoding number. The PIN is verified by comparing the received PIN to a PIN that was stored in the POS terminal 14 during its initial configuration setup. Upon verification the POS terminal 14 temporarily stores the random encoding number associated with the transaction number sent from the authentication gateway 18. The POS terminal 14 then originates a final encoded SMS message using the random encoding number and proceeds to send the message to the authentication gateway 18, as shown in step 212. This final SMS encoded message contains the necessary information for credit card payment, e.g., type of credit card, name on card, credit card number, expiration date, etc.

In step 214, the authentication gateway 18 terminates the encoded SMS message, decodes the message using the encryption code generated during the initial communications, e.g., the random encoding number, and extracts the POS terminal phone number, the transaction number, and the credit card payment information.

Once the authentication gateway 18 completes decoding the message, it validates the decoded information to ensure the required content has been received. Furthermore, the authentication gateway 18 accesses the merchant database 88 to locate the merchant web page address 106, as indicated in step 216. Next at step 218, the authentication gateway 18 generates the equivalent HTML code for the merchant's web site check out procedure. The code is constructed based on the HTML code format 108 retrieved from the merchant database 88. Embedded within the HTML code is the relevant credit card information, e.g., type of credit card, name on card, credit card number, expiration date, etc. and the relevant purchase information, e.g., time, date, product or service, value, etc. At step 220, the authentication gateway 18 sends the code to the merchant's web page using, for example, a secure online TCP/IP transmission. The HTML code contains all the necessary information to complete the checkout procedure and appears to the merchant's web page as if the merchant's customer were sending the information from a personal computer connected to the Internet at the time the transaction was completed.

The merchant web page, upon receiving the HTML code, proceeds to execute the code. The process from this point forward follows a standard Internet credit card transaction, which is well known by those having ordinary skill in the art. Briefly, the payment information is sent via a secure link to the credit card provider for authorization. Once authorized, funds are transferred into the merchant's bank account 24, as indicated in step 222.

Moving to steps 224 and 226, after the merchant's Internet payment process has been completed, an e-mail notification is sent from the e-commerce gateway 20 to the authentication gateway 18, which forwards the e-mail to the POS terminal 14. If the payment was accepted, the POS terminal 14 prints a receipt and the transaction is complete. If the payment was denied, the POS terminal 14 displays a message on the LCD and/or prints a message indicating that the payment was denied.

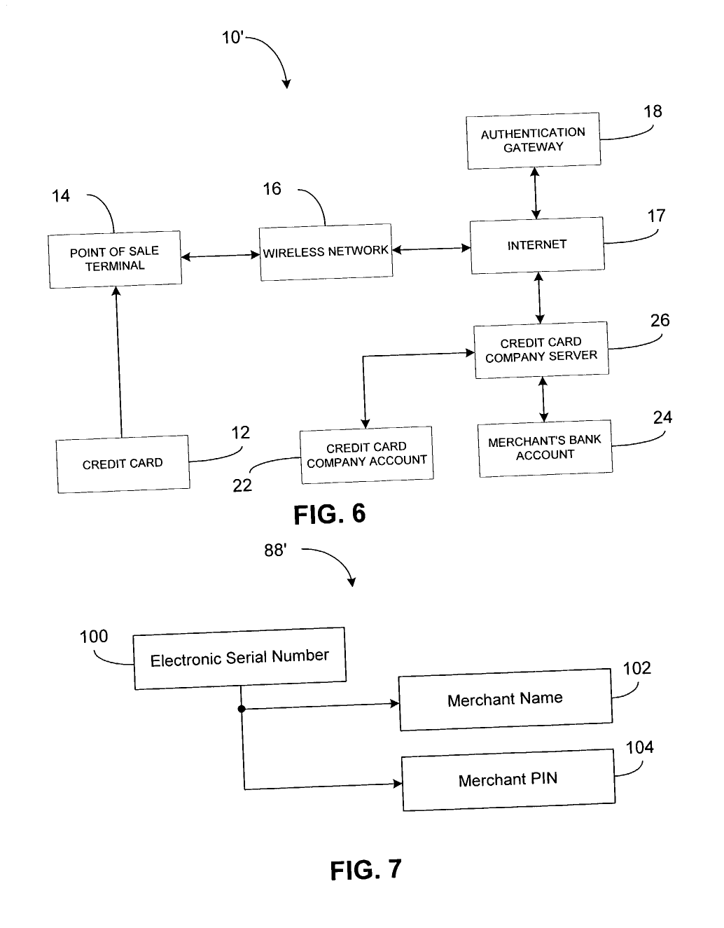

Referring now to FIG. 6, a point-of-sale (POS) payment system 10′ in accordance with another embodiment of the present invention is illustrated. The embodiment illustrated in FIG. 6 relates to POS payment transactions wherein the merchant deals with goods that are located at the sale site. Examples of such transactions include a hot dog vendor doing business in a baseball stadium and a fruit vendor doing business in an open market.

The POS payment system 10′ allows a merchant to accept payment via electronic transactions similar to the embodiment disclosed in FIG. 1. The POS payment system 10′ utilizes the POS terminal 14, wireless network 16 and Internet 17 to communicate the authentication gateway 18 in the same manner described in the embodiment of FIG. 1. The POS payment system 10′, however, facilitates electronic transactions in remote locations without interfacing to an e-commerce gateway. Instead, the POS system 10′ directly links to a credit card company's server 26.

The initial operation of the POS payment system 10′ is similar to the embodiment of FIG. 1. A credit card is read by the POS terminal 14 and a transaction amount is entered into the POS terminal 14 through the user interface 56. A secure link is established between the POS terminal 14 and the authentication gateway 18 via the wireless network 16 and the Internet 17. The POS terminal 14 transmits financial and order information to the authentication gateway 18, which in turn validates the information to ensure proper form and content, and proceeds to process the information.

At this point the POS payment system 10′ takes a different course from the embodiment of FIG. 1. Instead of connecting to an e-commerce gateway, the authentication gateway 18 directly connects to a credit card company server 26 via the Internet 17. A request is made by the authentication gateway 18 to the credit card company server 26 to transfer funds from the credit card company's account 22 to the merchant's account 24. The credit card company server 26 processes the request and either authorizes the request and performs the transfer or denies the request. Upon completion of the transaction (authorized or denied) an email message detailing the result of the transaction is sent from the credit card company server 26 to the authentication gateway 18, and the authentication gateway 18 forwards the message to the POS terminal 14. If the payment was accepted, the POS terminal 14 prints a receipt and the transaction is complete. If the payment was denied, the POS terminal 14 displays a message on the LCD and/or prints a message indicating that the payment was denied.

The POS payment system 10′ also includes a merchant database. The merchant database utilized in the POS payment system 10′ differs slightly from the database used in the embodiment of FIG. 1. Referring to FIG. 7, a merchant database 88′ utilized in the present embodiment is illustrated. The merchant database 88′ includes entries relating to the identity of the merchant requesting the credit card transaction. As before, the electronic serial number 100 is associated with various merchant specific entries. These entries include, for example, the merchant's name 102 and the merchant's PIN 104. The merchant's name 102 is used for identification purposes and the merchant's PIN 104 is used by the POS terminal 14 to validate the message received from the authentication gateway 18.

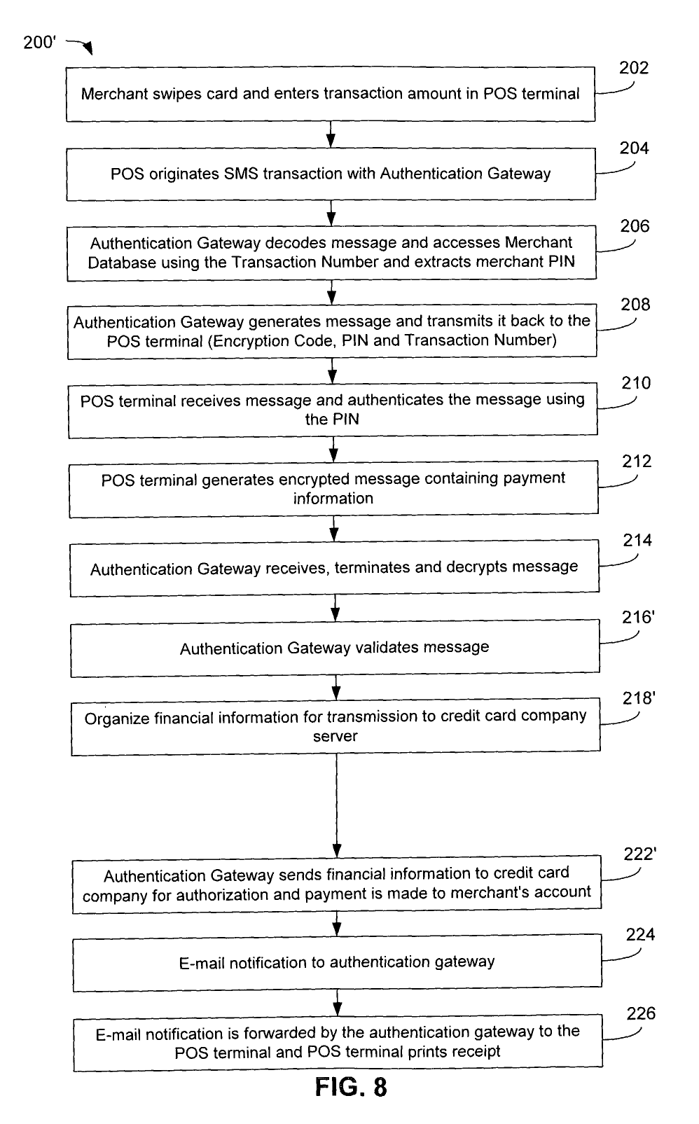

Referring now to FIG. 8, a flow chart 200′ is illustrated detailing the operation of the POS payment system 10′. Once a customer has selected the items he wishes to purchase, he proceeds to pay for the items. Using the customer's credit card, the merchant (or the customer) swipes the card through the card reader in the POS terminal 14 and enters the transaction amount using the keypad of the user interface 56, as shown in step 202. Optionally, the credit card information may be manually typed into the POS terminal 14 using the keypad of the user interface 56. Visual information relating to the status of the transaction is displayed on the LCD of the user interface 56. At step 204, the POS terminal 14 originates an SMS transaction with the authentication gateway 18 and sends the POS terminal phone number and a transaction number, e.g., the electronic serial number.

The authentication gateway 18 scans the received message and extracts the POS terminal phone number and the transaction number. Using the transaction number, the authentication gateway 18 accesses the merchant database 88′ and extracts a PIN corresponding to the transaction number, as shown at step 206. At step 208, the authentication gateway 18 generates a random encoding number and, using the POS terminal phone number, originates an SMS message back to the POS terminal 14. The SMS message from the authentication gateway 18 includes the PIN associated with the original transaction number, a transaction number, and the random encoding number.

At step 210, the POS terminal 14 receives the message from the authentication gateway 18, scans for the PIN, transaction number, and the random encoding number. Upon verifying that the PIN is correct, the POS terminal 14 temporarily stores the random encoding number associated with the transaction number sent from the authentication gateway 18. The POS terminal 14 then originates a final encoded SMS message using the random encoding number and proceeds to send the message to the authentication gateway 18, as shown in step 212. This final SMS encoded message contains the necessary information for credit card payment, e.g., type of credit card, name on card, credit card number, expiration date, etc.

In step 214, the authentication gateway 18 terminates the encoded SMS message, decodes the message using the encryption code generated during the initial communications, e.g., the random encoding number, and extracts the POS terminal phone number, the transaction number, and the credit card payment information.

Once the authentication gateway 18 completes decoding the message, it validates the decoded information to ensure the proper form and content has been received, as indicated in step 216′. At step 218′, the authentication gateway 18 organizes the financial information from the message and assembles a message containing the financial information for transmission to the credit card company server 26. At step 222′, the authentication gateway 18 sends the financial information via a secure link to the credit card company server 26 for authorization of payment. The credit card server 26 processes the request and makes a determination of whether to authorize or deny the request. If authorized by the server 26, funds are transferred into the merchant's bank account 24.

Moving to steps 224 and 226, after the merchant's Internet payment process is completed, an e-mail notification is sent back to the authentication gateway 18, which forwards the e-mail to the POS terminal 14. If the payment was accepted, the POS terminal 14 prints a receipt and the transaction is complete. If the payment was denied, the POS terminal 14 displays a message on the LCD and/or prints a message indicating that the payment was denied.

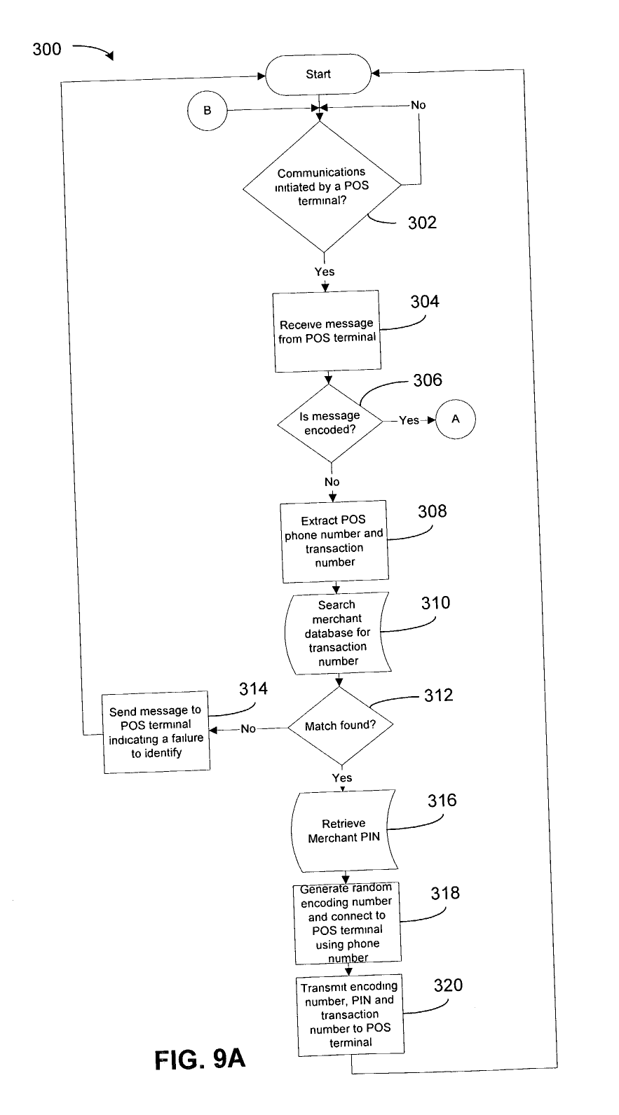

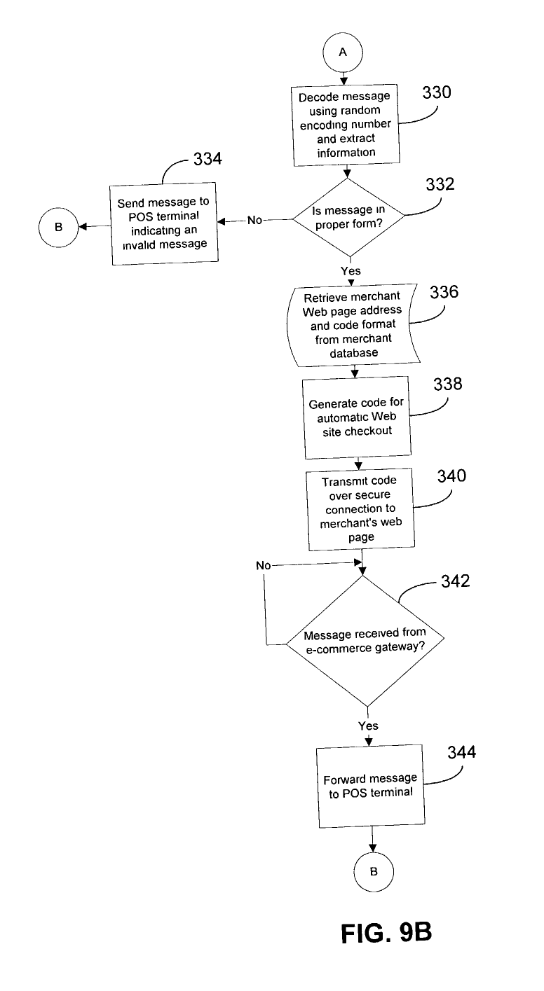

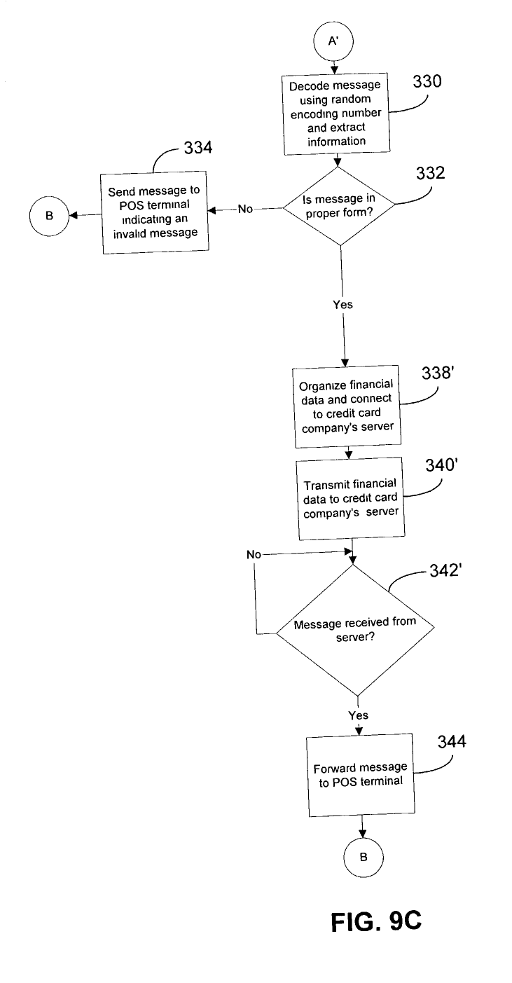

Referring now to FIG. 9A, a flow chart 300 further detailing the operation of the authentication gateway 18 is illustrated. Beginning at step 302, the authentication gateway determines whether the POS terminal 14 has initiated communications with the authentication gateway 18. If communications have not been initiated by the POS terminal 14, then the authentication gateway 18 continues checking for communications as shown at step 302. If communications have been initiated by the POS terminal 14, then the authentication gateway 18 receives the message from the POS terminal at step 304, and determines whether the message is encoded, as indicated at step 306. If the message is not encoded, then at step 308 the authentication gateway 18 extracts the POS terminal's phone number and transaction number from the message. At step 310, the authentication gateway accesses the merchant database 88 and searches for a transaction number 100 that matches the transaction number extracted from the message at step 308. If a match is not found, then the authentication gateway 18 sends a message to the POS terminal 14 indicating that an identification failure has occurred, as shown at step 312 and step 314, and the authentication gateway 18 returns to step 302 to monitor communications from the POS terminal. If a match is found, then the authentication gateway 18 retrieves the merchant's PIN from the merchant database and generates a random encoding number, as indicated in step 312, step 316 and step 318. At step 320, the authentication gateway 18 transmits a message, which includes the encoding number, PIN and transaction number, to the POS terminal 14. Upon completing transmission, the authentication gateway 18 returns to the beginning of the flowchart at step 302 and monitors for communications initiated by POS terminal 14.

Referring back to step 306 and with further reference to FIG. 9B, if the authentication gateway determines that the message is encoded, then the authentication gateway decodes the message using the random encoding number generated previously and extracts the information from the message, and shown at step 330. At step 332, the authentication gateway 18 determines if the message is in the proper form and has the proper content. If the information is not in the proper form and/or does not have the proper content, then the authentication gateway 18 sends a message to the POS terminal 14 indicating a validation error has been detected, as shown in step 334, and returns to step 302 to monitor for communications initiated by the POS terminal 14. If the message is determined to be of the proper form and content, then the authentication gateway 18 retrieves the merchant's web page address 106 and HTML code format 108, as shown at step 336. Using the HTML code format 108 for the merchant's web page, the authentication gateway 18 generates code for the automatic order entry and checkout procedure for the merchant's web page, as indicated in step 338. For example, a built in algorithm combines information from relating to the product information, price, customer information (e.g., billing information) and merchant information (including the merchant's web page order form) and creates a small “package of code”. The package of code is in a form understood by the merchant's web page.

Moving to step 340, the authentication gateway 18 transmits the package of code over a secure connection to the merchant's web page. At step 342, the authentication gateway 18 checks for a status message from the e-commerce gateway 20. If a message is received from the e-commerce gateway 20, then the authentication gateway 18 forwards the message to the POS terminal 14 as shown at step 344, and the authentication gateway 18 returns to step 302 and monitors for communications initiated by the POS terminal 14. If a message is not received, then the authentication gateway 18 continues to monitor for a message at step 342.

Operation of the authentication gateway 18 of the POS payment system 10′ is similar to the operation of the authentication gateway 18 of the POS payment system 10. Accordingly, only differences between the two embodiments will be discussed. Briefly, the authentication gateway 18 of the POS payment system 10′ operates in substantially the same manner as indicated in FIG. 9A. With regards to FIG. 9B, however, the embodiments are not the same. FIG. 9C details the operation of the authentication gateway 18 within POS payment system 10′. Entry into FIG. 9C occurs at step 306 of FIG. 1, which references connector “A”. FIG. 8C is shown using connector A′ to distinguish it from connector A of FIG. 9B. With regards to the POS payment system 10′, however, connector A′ may be deemed equivalent to connector A.

Referring to step 330 and step 332 of FIG. 9C, the authentication gateway 18 decodes the message from the POS terminal 14 using the random encoding number, extracts the information, and verifies that the information is in the proper form and has the proper content. If the information is not in the proper form and/or does not have the proper content, then the authentication gateway 18 sends a message to the POS terminal 14 indicating a validation error has been detected, as shown in step 334, and returns to step 302 to monitor for communications initiated by the POS terminal 14. If the information is in the proper form and has the proper content, then at step 338′ the authentication gateway 18 organizes the pertinent financial data related to the credit card transaction and connects to the credit card company's server 26. Moving to step 340′, the authentication gateway 18 transmits the financial data over a secure connection to the credit card company's server 26. At step 342′, the authentication gateway 18 checks for a status message from the server 26. If a message is received from the server 26, then the authentication gateway 18 forwards the message to the POS terminal 14 as shown at step 344. If a message is not received, then the authentication gateway 18 continues to monitor for the message at step 342.

It will be appreciated that the above described system and methods can be implemented using a computer. A person who has ordinary skill in the art of computer programming, using the flow charts provided in the drawings, may write code that a computer can execute to carry out the method for a POS payment system. For example, using the flow charts, code can be written that resides on the storage medium 86 and is executed by the CPU 80 of the authentication gateway 18 to automatically perform the steps described above.

While particular embodiments of the invention have been described in detail, it is understood that the invention is not limited correspondingly in scope, but includes all changes, modifications and equivalents coming within the spirit and terms of the claims appended hereto.

What is claimed is:

1. A point-of-sale payment system, comprising:
a point-of-sale (POS) terminal;
a wireless network;
an authentication gateway; and
an e-commerce gateway,
wherein the POS terminal communicates secure point-of-sale information with the authentication gateway through the wireless network, and the authentication gateway prepares instructions for a fund transfer and transmits the instructions to the e-commerce gateway, and the e-commerce gateway executes the instructions.

2. The point-of-sale payment system of claim 1, wherein the wireless network is a cellular phone network.

3. The point-of-sale payment system of claim 2, wherein the POS terminal communicates with the authentication gateway using short message service (SMS).

4. The point-of-sale payment system of claim 3, wherein the POS terminal includes a cellular phone transmitter and a cellular phone receiver.

5. The point-of-sale payment system of claim 3, wherein the POS terminal includes an interface for connecting to a cellular phone.

6. The point-of-sale terminal of claim 5, wherein the interface is selected from the group consisting of a serial link, an IEEE 802.11 interface, a Bluetooth interface, and an infra red interface.

7. The point-of-sale payment system of claim 1, wherein the authentication gateway transmits the instructions to the e-commerce gateway through an Internet connection.

8. The point-of-sale payment system of claim 7, wherein the e-commerce gateway includes a merchant's web page, and the merchant's web page includes a shopping cart interface.

9. The point-of-sale payment system of claim 8, wherein the instructions generated by the authentication gateway includes instructions to automatically place an order for the at least one item and to submit payment for the at least one item through the merchant's web page.

10. The point-of-sale payment system of claim 9, wherein the instructions are comprised of Hyper Text Markup Language (HTML).

11. The point-of-sale payment system of claim 1, wherein the communications between the POS terminal and the authentication gateway is encrypted.

12. The point-of-sale payment system of claim 1, wherein the communications between the POS terminal and the authentication gateway operates on a narrow band channel.

13. The point-of-sale payment system of claim 12, wherein the narrow band channel operates at less than 64 kHz.

14. The point-of-sale payment system of claim 1, wherein the POS terminal includes a card reader, a user interface and a printer

15. The point-of-sale payment system of claim 14, wherein the printer is a thermal printer.

16. The point-of-sale payment system of claim 14, wherein the e-commerce gateway notifies the authentication gateway as to the status of the code execution, and the authentication gateway forwards the status to the POS terminal.

17. The point-of-sale payment system of claim 16, wherein the POS terminal prints a hard copy of a successful transaction.

18. The point-of-sale payment system of claim 14, wherein the card reader is a magnetic card reader.

19. The point-of-sale payment system of claim 14, wherein the card reader is an electronic card reader.

20. The point-of-sale payment system of claim 14, wherein the user interface includes a keypad and a display screen.

21. An apparatus for facilitating a point of sale (POS) payment transaction, comprising:
a storage device;
a processor connected to the storage device; and
a program for controlling the processor, said program stored on the storage device,
wherein the processor is operative with the program to receive a remote payment request from a merchant, wherein said processor identifies the merchant, creates instructions for facilitating the payment request and transmits the instructions to a web page for performing the payment request.

22. The apparatus of claim 21, wherein the processor receives the remote payment request through a wireless network.

23. The apparatus of claim 22, wherein the wireless network includes a narrow band .

24. The apparatus of claim 22, wherein the wireless network is a cellular phone network.

25. The apparatus of claim 24, wherein the wireless network includes Short Message Service (SMS).

26. The apparatus of claim 21, wherein the web page is operated by the merchant.

27. The apparatus of claim 21, wherein the processor transmits the instructions to the web page through an Internet connection.

28. The apparatus of claim 21, wherein the processor receives a confirmation message relating to the payment transaction and forwards the message to the merchant.

29. The apparatus of claim 21, wherein the remote payment request is encrypted.

30. A method for using a computer to facilitate a point-of-sale payment between a buyer and a merchant, comprising the steps of:
inputting financial information relating to the buyer into the computer;
identifying the merchant requesting the transaction;
creating code that automatically fills in purchase information on a merchant's web page; and
transmitting the code to the merchant's web page, wherein the merchant's web page executes the code.

31. The method of claim 30, wherein the step of executing the code includes transferring funds from an account to a merchant's account.

32. The method of claim 31, wherein the step of transferring funds from an account includes a credit card account.

33. The method of claim 31, wherein the step of transferring funds from an account includes a bank account.

34. The method of claim 31, wherein the step of executing the code further includes entering an order into an order entry system.

35. The method of claim 31, wherein the step of inputting financial information includes reading the financial information from a card at a remote location, and transmitting the financial information to the computer over a wireless network.

36. The method of claim 35, wherein the step of transmitting the financial information over a wireless network further includes using a narrow band channel.

37. The method of claim 35, wherein the step of transmitting the financial information over a wireless network further includes using a Short Message Service (SMS).

38. A point-of-sale payment method, comprising the steps of:
communicating financial information from a point-of-sale (POS) terminal to an authentication gateway, wherein the communications are secure and conducted through a wireless network;
constructing instructions for an e-commerce gateway to perform an electronic fund transfer, wherein the instructions are constructed by the authentication gateway; and
transmitting the instructions to the e-commerce gateway, wherein the e-commerce gateway executes the instructions and reports a result to the authentication gateway, and the authentication gateway reports the result to the POS terminal.

39. The method of claim 38, wherein the step of constructing instructions includes assembling code to be executed by a web page in the e-commerce gateway.

40. The method of claim 38, wherein the step of communicating financial information includes reading the financial information from a card at a remote location.

41. The method of claim 40, wherein the step of communicating financial information further includes using a narrow band channel.

42. The method of claim 40, wherein the step of communicating financial information further includes using a Short Message Service (SMS).
